(19) United States
(12) Patent Application Publication
(10) Pub. No.: US 2004/0076406 A1
(43) Pub. Date: Apr. 22, 2004

(54) Information recording apparatus and method

(75) Inventors: Shinichi Kikuchi, Kawasaki-shi (JP); Masaaki Ariyoshi, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/662,483

(22) Filed: Sep. 16, 2003

(30) Foreign Application Priority Data
Oct. 16, 2002 (JP) 2002-301902

(51) Int. Cl. H04N 5/781

(52) U.S. Cl. 386/95; 386/98; 386/125

(57) ABSTRACT

An information recording apparatus according to one aspect of this invention has an input unit configured to input data, a detection unit configured to detect audio attribute information from input data input by the input unit, and a recording unit configured to record audio information contained in the input data and the audio attribute information in a predetermined format.

### CROSS-REFERENCE TO RELATED APPLICATIONS

This application is based upon and claims the benefit of priority from the prior Japanese Patent Application No. 2002-301902, filed Oct. 16, 2002, the entire contents of which are incorporated herein by reference.

### BACKGROUND OF THE INVENTION

1. Field of the Invention

The present invention relates to an information recording apparatus and method for recording audio information on an optical disk such as a DVD-RAM or the like.

2. Description of the Related Art

In recent years, moving image-compatible optical disk reproduction apparatuses which reproduce optical disks that record video data, audio data, and the like have been developed, and have prevailed for the purpose of reproducing movie software, karaoke software, and the like such as LDs, video CDs, and the like.

In these apparatuses, a DVD standard that adopts MPEG2 (Moving Picture Coding Expert Group) and AC3 Audio compression as international standards has been proposed.

This standard supports MPEG2 as a moving image compression scheme according to the MPEG2 system layer, and AC3 Audio and MPEG Audio as audio compression schemes. Furthermore, sub-picture data obtained by runlength-compressing bitmap data for subtitles, and special reproduction control data (navigation packs) such as fastforwarding, rewinding, and the like are added.

Moreover, this standard supports ISO9660 and micro UDF to allow a computer to read data.

As the standards of media themselves, the DVD-RAM standard has been achieved after the DVD-ROM standard used in DVD-Video, and DVD-RAM drives are beginning to be prevalent as computer peripheral devices.

Furthermore, Jpn. Pat. Appln. KOKAI Publication No. 10-208403 discloses a DVD audio disk apparatus which can record data by linear PCM at a sampling frequency of 192 kHz using a maximum number of channels limited by 24 bits.

However, existing DVD recorders cannot sufficiently cope with an input signal with high sound quality, which is input from, e.g., a digital input unit.

### BRIEF SUMMARY OF THE INVENTION

An information recording apparatus according to an aspect of the present invention comprises an input unit configured to input data, a detection unit configured to detect audio attribute information from input data input by the input unit, and a recording unit configured to record audio information and the audio attribute information contained in the input data in a predetermined format.

An information recording method according to an aspect of the present invention comprises detecting audio attribute information from input data, and recording audio information and the audio attribute information contained in the input data in a predetermined format.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing the arrangement of an information recording/reproduction apparatus according to an embodiment of the present invention;

FIG. 2 shows an example of a directory structure formed in a DVD;

FIG. 3 is a schematic view showing the data structure of an AOBS contained in AR_AUDIO.ARO shown in FIG. 2;

FIG. 4 is a schematic view showing the data structure of AR_MANGR.IFO shown in FIG. 2;

FIG. 5 shows an LPCM pack structure;

FIG. 6 shows an AC3 pack structure;

FIG. 7 is a flow chart for explaining an audio data recording process on a DVD by the information recording/reproduction apparatus shown in FIG. 1;

FIG. 8 is a flow chart for explaining an AOB_STI setup process by the information recording/reproduction apparatus shown in FIG. 1;

FIG. 9 shows an example of the arrangement and operation of a first audio attribute information detector;

FIG. 10 shows an example of the data format of input data input via a LAN I/F unit; and

FIG. 11 is a flow chart for explaining the recording process of input data input via the LAN I/F unit.

### DETAILED DESCRIPTION OF THE INVENTION

An embodiment of the present invention will be described hereinafter with reference to the accompanying drawings.

A DVD stores data in a normal file format. Furthermore, a title corresponds to one movie, and a plurality of titles are saved on a single disk. A group of titles is called a title set, which consists of a plurality of files.

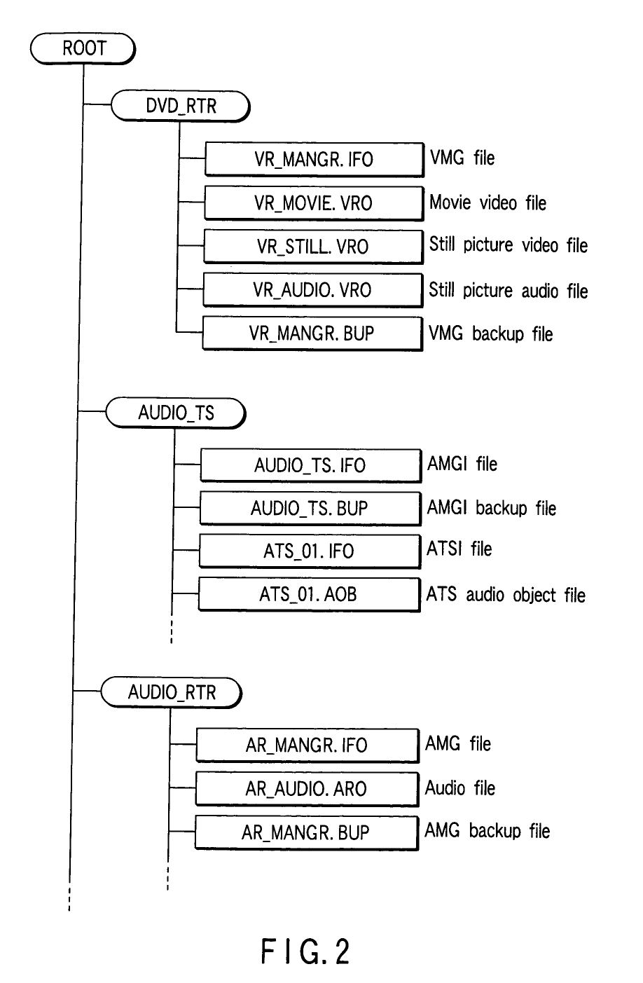

FIG. 2 shows an example of the directory structure in a DVD disk. As shown in FIG. 2, directories are formed in correspondence with standards in a DVD disk: for example, a VIDEO_TS directory corresponding to the DVD-Video standard, an AUDIO_TS directory corresponding to the DVD-Audio standard, a DVD_RTR directory corresponding to the RTR (Real Time Recording)-DVD standard, and an AUDIO_RTR directory corresponding to the DVD-AR (Audio Recording) standard. Respective recording data are present in these directories.

The DVD-AR standard is specified to record audio data with high sound quality. This standard supports:

Sampling frequency=48, 96, 192 (kHz)

Bitwidth=16, 20, 24 bits

Channel=6 (max)

As shown in FIG. 2, the DVD_RTR directory contains VR_MANGR.INF, VR_MOVIE.VRO, VR_STILL.VRO, VR_AUDIO.VRO, and VR_MANGR.BUP.

The AUDIO_TS directory contains AUDIO_TS.INF, AUDIO_TS.BUP, ATS_{—}01.INF, and ATS_{—}01.AOB.

The AUDIO_RTR directory contains AR_MANGR.INF (management file), AR_AUDIO.ARO (audio file), and AR_MANGR.BUP (AMG backup file).

For example, in the DVD-Video standard, a file called a Video Manager (to be referred to as VMG hereinafter) is present in one disk as information used to manage video data in this disk. Likewise, in the RTR-DVD standard, the aforementioned file called VR_MANGR.INF (to be referred to as VMG hereinafter) is present in one disk as information used to manage video data in this disk. Also, in the DVD-AR standard, AR_MANGR.INF (to be referred to as AMG hereinafter) is present in one disk as information used to manage audio data in this disk.

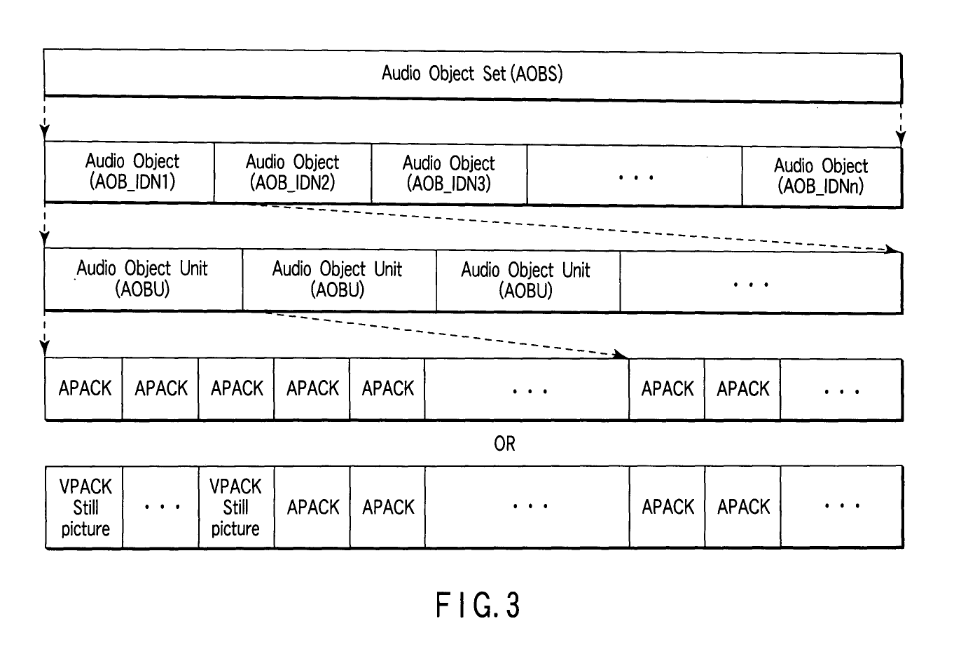

Details of AR_AUDIO.ARO will be explained below with reference to FIG. 3. FIG. 3 is a schematic view showing the data structure of an audio object set (AOBS) contained in AR_AUDIO.ARO. When audio data complying with the DVD-AR standard is stored in one DVD, one AR_AUDIO.ARO is stored in one DVD.

The AOBS contains a plurality of audio objects (AOBs). Each AOB contains a plurality of audio object units (AOBUs). Each AOBU contains a plurality of video packs (VPACKs) and a plurality of audio packs (APACKs). Each pack contains one or more packets and a pack header. The pack is a minimum unit upon executing a data transfer process. Furthermore, a minimum unit upon executing a logical process is a cell, and the logical process is done using this unit.

The reproduction order of audio data is defined by a program chain (PGC). A plurality of programs (PGs) are registered in this PGC. Cells are registered in each PG, and AOBs to be reproduced are registered in each cell.

Program chain information (PGCI) actually records the structure of the PGC. A reproduction process is done according to the PGCI, which is generated upon recording or editing.

In a recordable/reproducible DVD, a special PGC required to reproduce in the recording order is called an original PGC, and information of this original PGC is recorded in ORG_PGCI.

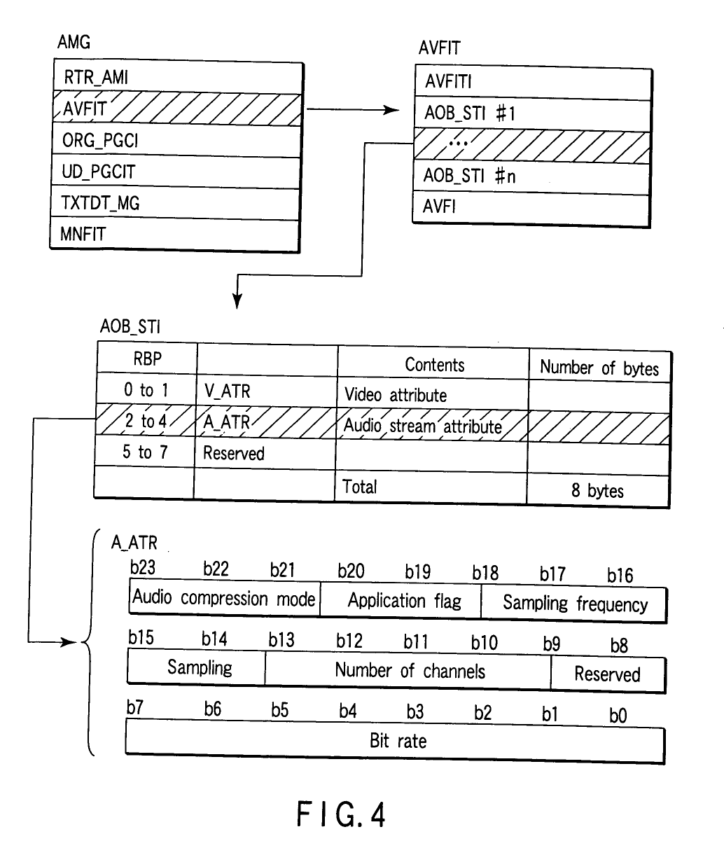

Details of AR_MANGR.INF (AMG) will be described below with reference to FIG. 4. FIG. 4 is a schematic view showing the data structure of the AMG. The AMG contains RTR audio manager information (RTR_AMGI), an AV file information table (AVFIT), original PGC information (ORG_PGCI), a user-defined PGC information table (UD_PGCIT), a text data manager (TXT_MG), and a manufacturer's information table (MNFIT).

The AVFIT contains AVFIT information (AVFITI), AOB stream information (AOB_STI), and an AV information table (AVFI).

The AOB_STI contains a video attribute (V_ATR) and audio attribute (A_ATR).

The A_ATR contains information of an audio compression mode, sampling frequency, sampling bitwidth, the number of channels, bit rate, and the like. As the audio compression mode, AC3, MPEG1, MPEG2, LPCM, and the like are available. As the sampling frequency, 48 kHz, 96 kHz, 192 kHz, 44.1 kHz, 88.2 kHz, 176.4 kHz, and the like are available. As the sampling bitwidth, 16 bits, 20 bits, 24 bits, and the like are available. As the number of channels, MONO, STEREO, 6ch, DUAL MONO, and the like are available. As the bit rate, 64 kbps, 80 kbps, 96 kbps, 112 kbps, 128 kbps, 160 kbps, 192 kbps, 224 kbps, 256 kbps, 320 kbps, 384 kbps, 448 kbps, 768 kbps, 1536 kbps, and the like are available. Upon reproducing a DVD, an audio decoding unit 24 executes various initial setups on the basis of information contained in the A_ATR.

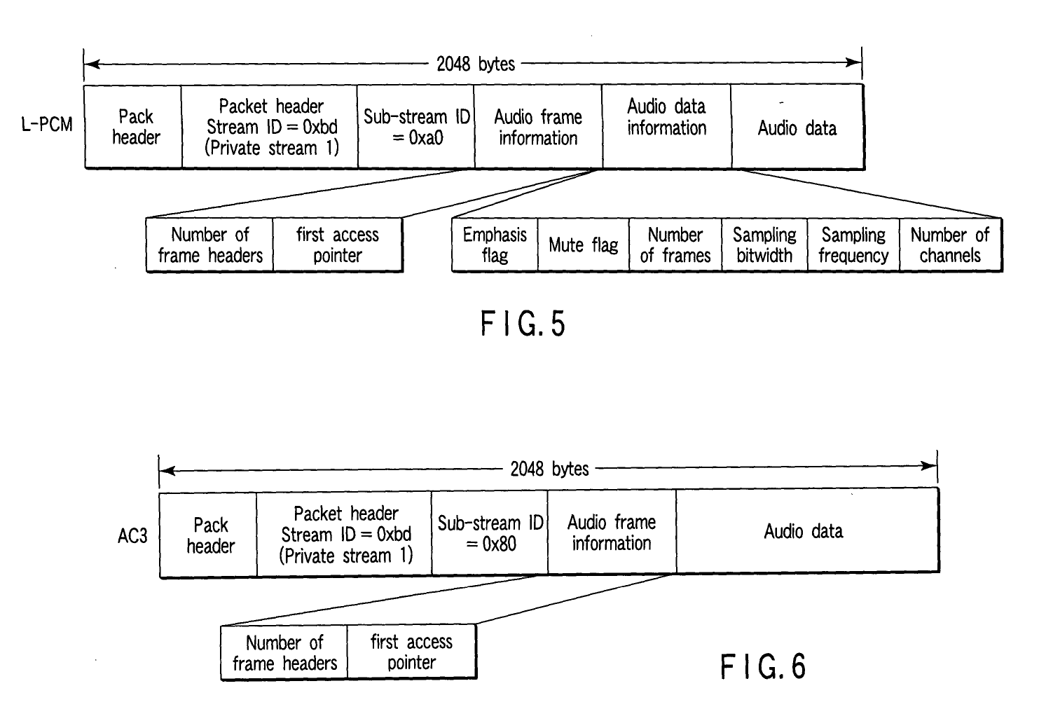

FIG. 5 shows the LPCM pack structure. As shown in FIG. 5, one LPCM pack consists of 2048 bytes. One LPCM pack contains a pack header, packet header, sub-stream ID, audio frame information, audio data information, and audio data. The audio frame information contains information of the number of frame headers and a first access pointer. The audio data information contains information of an emphasis flag, mute flag, the number of frames, sampling bitwidth, sampling frequency, and the number of channels.

FIG. 6 shows the AC3 pack structure. As shown in FIG. 6, one AC3 pack consists of 2048 bytes. One AC3 pack contains a pack header, packet header, sub-stream ID, audio frame information, and audio data. The audio frame information contains information of the number of frame headers and a first access pointer.

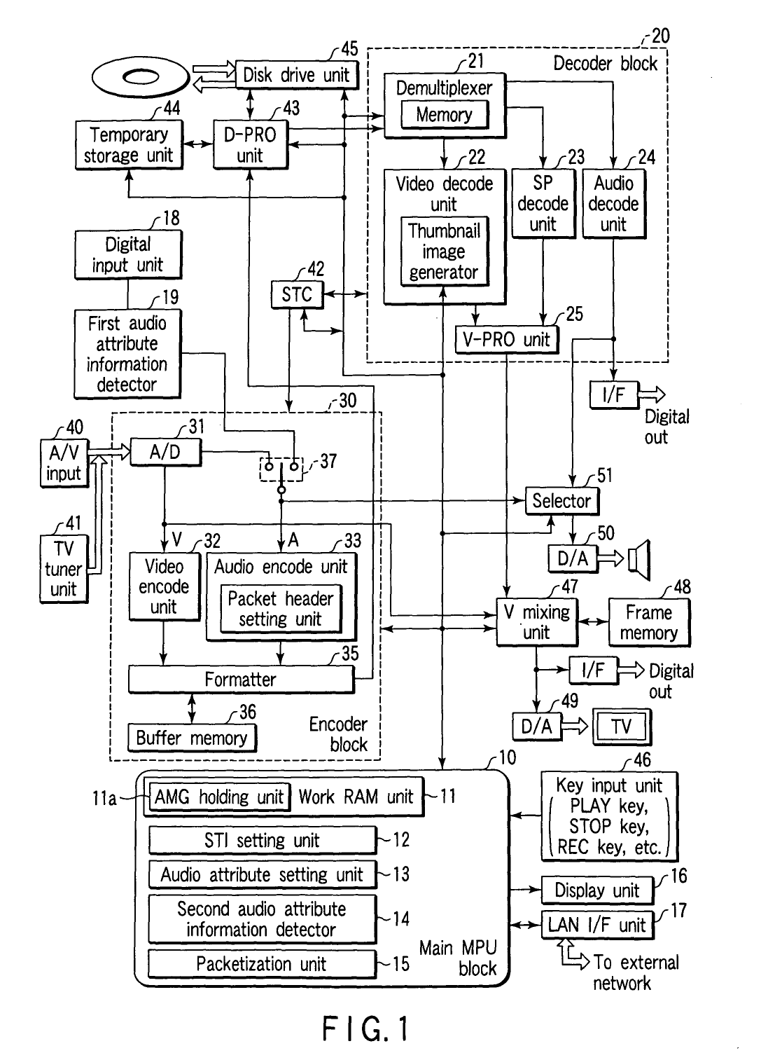

An information recording/reproduction apparatus which records information such as video data, music data, and the like on the aforementioned DVD, and reproduces such information from the DVD will be described below with reference to FIG. 1. FIG. 1 is a schematic block diagram showing the arrangement of an information recording/reproduction apparatus according to an embodiment of the present invention.

As shown in FIG. 1, the information recording/reproduction apparatus comprises an MPU block 10, display unit 16, LAN I/F unit 17, digital input unit 18, first audio attribute information detector 19, decoder block 20, encoder block 30, A/V input unit 40, TV tuner unit 41, STC (System Time Counter) unit 42, D-PRO unit 43, temporary storage unit 44, disk drive unit 45, key input unit 46, V mixing unit 47, frame memory 48, video output D/A unit 49, audio output D/A unit 50, selector unit 51, and the like.

The MPU block 10 comprises a work RAM unit 11, STI setting unit 12, audio attribute information setting unit 13, second audio attribute information detector 14, packetization unit 15, and the like. Furthermore, the work RAM unit 11 comprises an AMG holding unit 11a for holding an AMG read out from a DVD. The STI setting unit 12 controls the setups of AOB_STI shown in FIG. 4. The audio attribute information setting unit 13 controls the setups of audio attribute information.

The encoder block 30 comprises an A/D unit 31, video encode unit 32, audio encode unit 33, formatter 35, buffer memory 36, audio signal selector 37, and the like. The decoder block 20 comprises a demultiplexer 21, video decode unit 22, SP decode unit 23, audio decode unit 24, V-PRO unit 25, and the like.

The flow of an AV signal is as follows. An AV signal input via the A/V input unit 40 or TV tuner unit 41 is converted into a digital signal by the A/D unit 31. A video signal contained in the digital AV signal is input to the video encode unit 32. An audio signal contained in the digital AV signal is input to the audio encode unit 33 when it is selected by the audio signal selector 37. Or input data (audio signal) input via the digital input unit 18 is input to the audio encode unit 33 when it is selected by the audio signal selector 37. The video encode unit 32 compresses the video signal by MPEG and packetizes the compressed video signal. The audio encode unit 33 compresses the audio signal by AC3 or MPEG-Audio, and packetizes the compressed audio signal. The video encode unit 32 inputs the packetized video data to the formatter 35. Likewise, the audio encode unit 33 inputs the packetized audio data to the formatter 35. Note that the compressed data is packetized to obtain 2048 bytes upon packing the compressed data. The formatter 35 packs packet data, multiplexes the packed data, and transfers the multiplexed data to the D-PRO unit 43.

If input data (audio signal) input via the LAN I/F unit 17 is data in a pack format complying with the DVD-AR data format, the input audio signal is directly transferred to the D-PRO unit 43. If the input audio signal is not data in a pack format complying with the DVD-AR data format, the input audio signal is converted into the pack format by the packetization unit 15, and the pack data are transferred to the D-PRO unit 43. The D-PRO unit 43 appends twice an error correction code to every 16 packs to form ECC (Error Correction Code) blocks. The ECC block data generated by the D-PRO unit 43 are recorded on a disk by the disk drive unit 45.

When the disk drive unit 45 is busy since its seek or track jump operation is in progress, data to be recorded is stored in the temporary storage-unit 44 and waits until the disk drive unit 45 is ready.

Next, detection of audio attribute information by the first and second audio attribute information detectors 19 and 14, and allocation of the detected audio attribute data will be described below. The first audio attribute information detector 19 detects audio attribute information from input data, which is input via the digital input unit 18. The second audio attribute information detector 14 detects audio attribute information from input data, which is input via the LAN I/F unit 17. The audio attribute information includes information of a compression mode, sampling frequency, sampling bitwidth, and the like.

The audio encode unit 33 allocates the audio attribute information in a management file on a disk. That is, the audio encode unit 33 allocates the audio attribute information in AR_MANGR.INF. More specifically, the audio encode unit 33 allocates the audio attribute information in A_ATR in AOB_STI contained in AR_MANGR.INF.

Alternatively, the formatter 35 allocates the audio attribute information in an audio file on a disk. That is, the formatter 35 allocates the audio attribute information in AR_AUDIO.ARO. More specifically, the formatter 35 allocates the audio attribute information in an APACK in an AOBU contained in AR_AUDIO.ARO together with audio information.

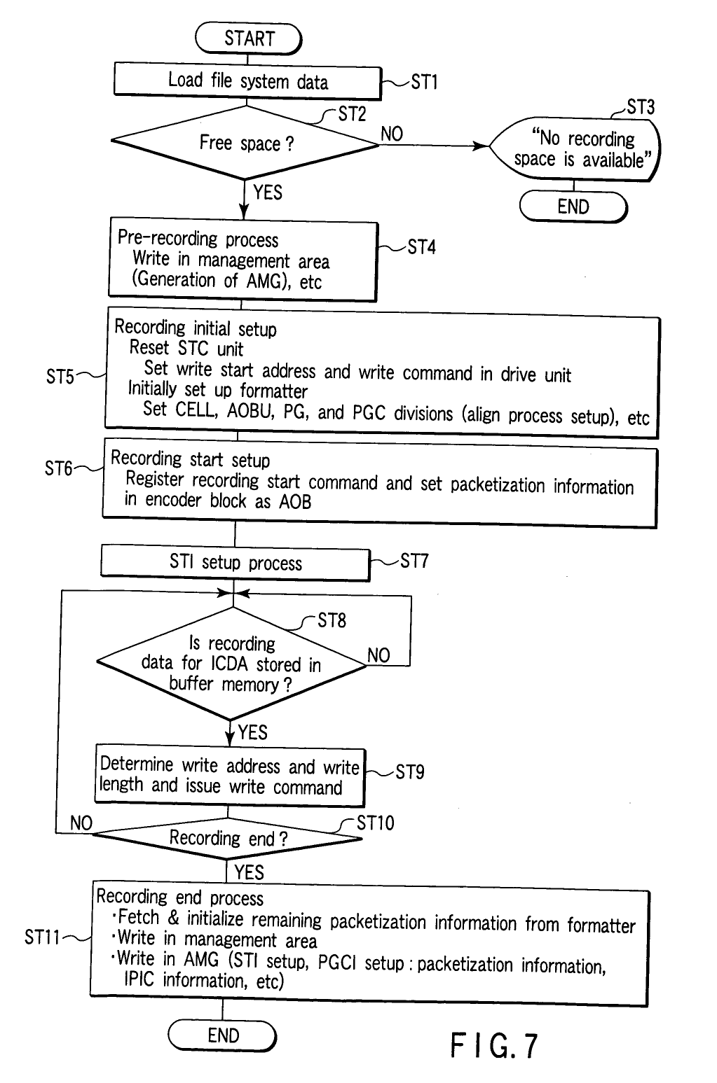

A recording process of audio data on a DVD-RAM by the information recording/reproduction apparatus shown in FIG. 1 will be described below with reference to the flow chart shown in FIG. 7.

Upon data recording, the following processes are executed.

ST1: The file system of a DVD-RAM is loaded. At this time, the file system of the DVD-RAM is checked, and if no file system is available, a file system is formed.

ST2, ST3: If the DVD-RAM has no free space, a guide message “no recording space is available” or the like is displayed.

ST4: A pre-recording process is executed. That is, the directories of the DVD-RAM are checked, and if no AUDIO_RTR directory is available, an AUDIO_RTR directory is generated. RTR_AMGI is read out from the AUDIO_RTR directory on the DVD-RAM. If no RTR_AMGI is available, RTR_AMGI is generated, and an AMGI table is formed.

ST5: Recording initial setups are made.

ST6: Recording start setups are made.

ST7: An STI setup process is executed. STI is set on the basis of audio attribute information detected by the first and second audio attribute information detectors 19 and 14. That is, audio attribute information is allocated in A_ATR in AOB_STI contained in AR_MANGR.IFO on the basis of the detected audio attribute information. Alternatively, audio attribute information is allocated in an APACK in an AOBU contained in AR_AUDIO.ARO together with audio information.

ST8: If encoded data for one CDA are stored, the disk drive unit 45 is set to record the data on a free area of the DVD-RAM, and link information of a sector as a recording destination is saved in the work RAM unit 11. If encoded data for one CDA are not stored, the process in step ST8 is repeated until encoded data for one CDA are stored.

ST9: A write address and write length are determined, and a write command is issued to the disk drive unit 45.

ST10: The processes in steps ST8 and ST9 are repeated until a recording end command is issued.

ST11: A recording end process is executed. The file system of the DVD-RAM is updated based on the link information. AMG is updated based on AMGI, and is recorded on the DVD-RAM. Upon updating the AMG, newly set AOBESTI is recorded on the DVD-RAM.

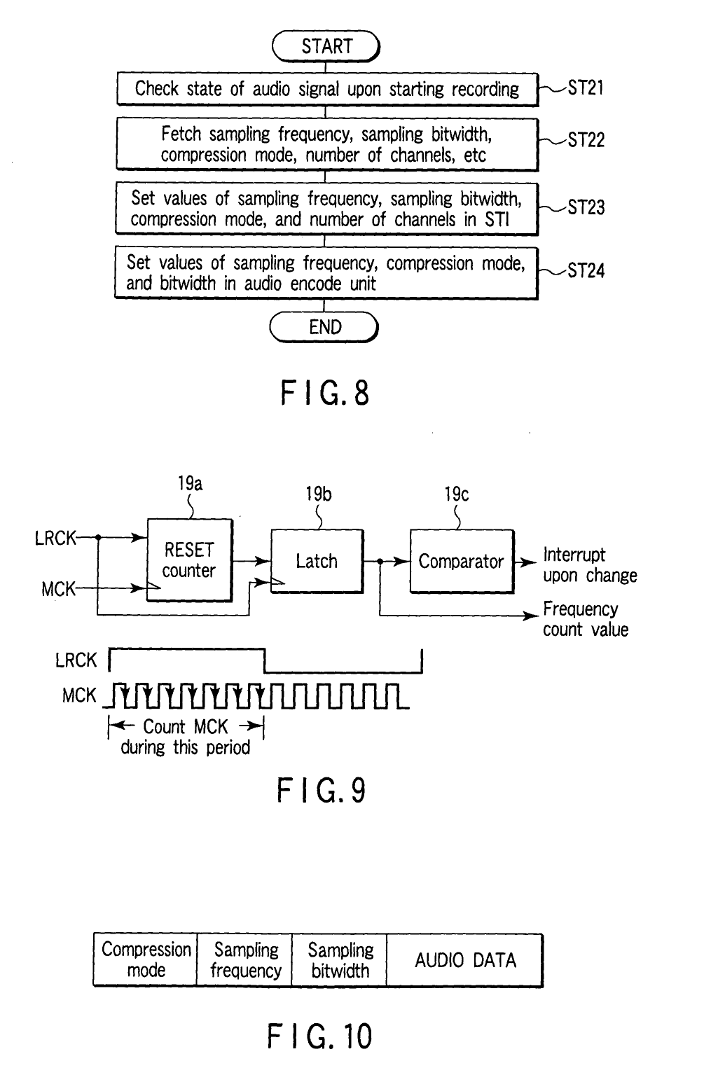

The AOB_STI setup process by the information recording/reproduction apparatus shown in FIG. 1 will be described below with reference to the flow chart shown in FIG. 8.

ST21: Upon starting recording, input data is checked.

ST22: The first or second audio attribute information detector 19 or 14 detects audio attribute information from input data. That is, the detector fetches information such as a sampling frequency, sampling bitwidth, compression mode, the number of channels, and the like.

ST23: The fetched information (sampling frequency, sampling bitwidth, compression mode, the number of channels, and the like) is set in AOB_STI.

ST24: The fetched information (sampling frequency, sampling bitwidth, compression mode, the number of channels, and the like) is set in the audio encode unit 33. As a result, the audio encode unit 33 records information of the sampling frequency, sampling bitwidth, and compression mode as audio information in each packet.

The first audio attribute information detector 19 will be described below with reference to FIG. 9. FIG. 9 shows a schematic arrangement and operation of the first audio attribute information detector 19. As shown in FIG. 9, the first audio attribute information detector 19 comprises a counter 19a, latch 19b, and comparator 19c. Input data (IIS), which is input via the digital input unit 18, contains an LR clock (LRCK) as a right/left data switching signal. An internally generated master clock (MCK) and the LRCK are input to the counter 19a. The counter 19a and latch 19b count high (H) or low (L) periods of the LRCK on the basis of the MCK. That is, the counter 19a and latch 19b detect the length of the half period of the LRCK. The count result (the length of the half period of the LRCK) of the counter 19a and latch 19b is sent to the MPU block 10. The MPU block 10 detects the sampling frequency from the count result. The comparator 19c compares the length of a given half period of the LRCK with that of a half period which follows the given half period. If the lengths of these half periods are different by a predetermined length or more (two clocks or more), the comparator 19c advises the MPU block 10 accordingly by an interrupt.

Detection of audio attribute information by the second audio attribute information detector 14 will be described below with reference to FIG. 10. FIG. 10 shows an example of the data format of input data, which is input via the LAN I/F unit 17. This input data is acquired from, e.g., a home page or the like via the Internet. As shown in FIG. 10, the input data contains audio attribute information (information such as a compression mode, sampling frequency, sampling bitwidth, and the like), and audio data. The second audio attribute information detector 14 detects the audio attribute information contained in the input data.

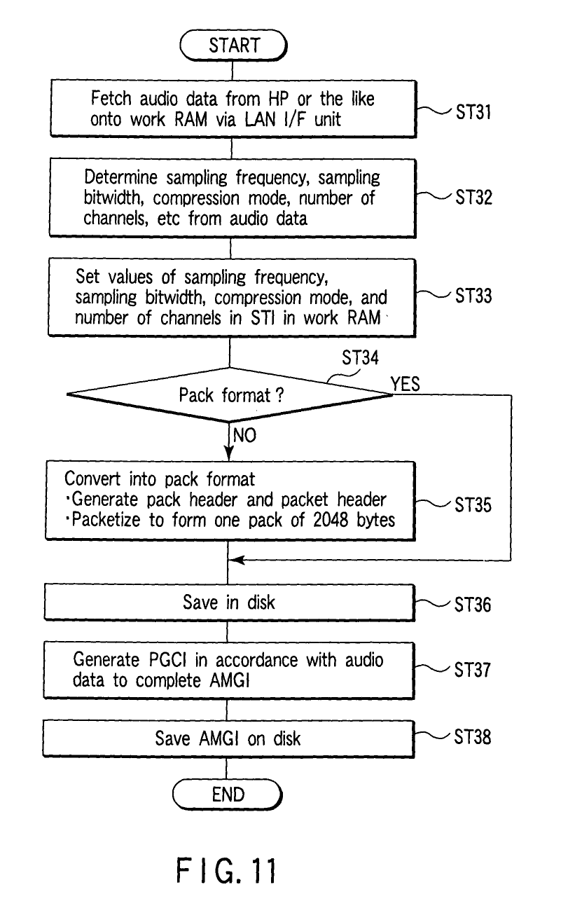

A recording process of input data, which is input via the LAN I/F unit 17, will be described below with reference to FIG. 11.

ST31: Input data with the data format shown in FIG. 10 is fetched from a home page or the like onto the work RAM unit 11 via the LAN I/F unit 17.

ST32: The second audio attribute information detector 14 detects audio attribute information from the input data fetched onto the work RAM unit 11. Also, the detector 14 acquires the compression mode, sampling frequency, sampling bitwidth, the number of channels, and the like contained in the detected audio attribute information.

ST33: The acquired information (compression mode, sampling frequency, sampling bitwidth, the number of channels, and the like) is set in AOB_STI.

ST34: It is checked if the input data fetched onto the work RAM unit 11 is data with the pack format.

ST35: If it is determined in step ST34 that the input data does not have the pack format, the input data is converted into the pack format. That is, a pack header and packet header are generated to generate one pack consisting of 2048 bytes.

ST36: If it is determined in step ST34 that the input data has the pack format, or if data in the pack format is generated in step ST35, the data is saved on a DVD-RAM. Audio data contained in the input data is recorded in AR_AUDIO.ARO in the DVD-RAM.

ST37: PGCI is generated in accordance with the input data to complete RTR_AMGI.

ST38: The RTR_AMGI is recorded in a file of AR_MANGR.IFO in the DVD-RAM.

As described above, the information recording/reproduction apparatus of the present invention can record high-quality audio data in a DVD in conformity to the DVD-AR standard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording apparatus comprising:
an input unit configured to input data;
a detection unit configured to detect audio attribute information from input data input by the input unit; and
a recording unit configured to record audio information and the audio attribute information contained in the input data in a predetermined format.

2. An apparatus according to claim 1, wherein the predetermined format contains a management file and an audio file,
the management file contains the audio attribute information, and
the audio file contains the audio information.

3. An apparatus according to claim 1, wherein the predetermined format contains a management file and an audio file,
the management file contains stream information,
the stream information contains the audio attribute information, and
the audio file contains the audio information.

4. An apparatus according to claim 1, wherein the predetermined format contains a management file and an audio file,
the management file contains management information,
the audio file contains a pack as a data transfer processing unit, and
the pack contains the audio attribute information and the audio information.

5. An apparatus according to claim 1, wherein the detection unit detects a sampling frequency corresponding to the audio attribute information on the basis of a plurality of clocks contained in the input data.

6. An apparatus according to claim 1, wherein the detection unit detects a length of a half period of an LR clock contained in the input data on the basis of a master clock, and detects information associated with a sampling frequency corresponding to the audio attribute information on the basis of the detection result.

7. An apparatus according to claim 1, wherein the detection unit detects the audio attribute information contained in the input data.

8. An apparatus according to claim 1, wherein the audio attribute information contains at least one information of information indicating a compression mode, information indicating a sampling frequency, and information indicating a sampling bitwidth.

9. An information recording method comprising:
detecting audio attribute information from input data; and
recording audio information and the audio attribute information contained in the input data in a predetermined format.

10. A method according to claim 9, wherein the predetermined format contains a management file and an audio file,
the management file contains the audio attribute information, and
the audio file contains the audio information.

11. A method according to claim 9, wherein the predetermined format contains a management file and an audio file,
the management file contains stream information,
the stream information contains the audio attribute information, and
the audio file contains the audio information.

12. A method according to claim 9, wherein the predetermined format contains a management file and an audio file,
the management file contains management information,
the audio file contains a pack as a data transfer processing unit, and
the pack contains the audio attribute information and the audio information.

13. A method according to claim 9, wherein a sampling frequency corresponding to the audio attribute information is detected on the basis of a plurality of clocks contained in the input data.

14. A method according to claim 9, wherein a length of a half period of an LR clock contained in the input data is detected on the basis of a master clock, and information associated with a sampling frequency corresponding to the audio attribute information is detected on the basis of the detection result.

15. A method according to claim 9, wherein the audio attribute information contained in the input data is detected.

16. A method according to claim 9, wherein the audio attribute information contains at least one information of information indicating a compression mode, information indicating a sampling frequency, and information indicating a sampling bitwidth.
